(19) United States
(12) Patent Application Publication
(10) Pub. No.: US 2026/0108866 A1
(43) Pub. Date: Apr. 23, 2026

(54) KILOGRAM-SCALE HIGH-LOADING IRON SINGLE-ATOM CATALYST, AND PREPARATION METHOD AND USE THEREOF

(71) Applicant: Zhejiang University, Hangzhou City (CN)

(72) Inventors: Jiang XU, Hangzhou City (CN); Xunheng JIANG, Hangzhou City (CN); Can LI, Hangzhou City (CN); Jiaqing CHEN, Hangzhou City (CN); Xinhua XU, Hangzhou City (CN); Daohui LIN, Hangzhou City (CN)

(21) Appl. No.: 19/204,842

(22) Filed: May 12, 2025

(30) Foreign Application Priority Data
Oct. 21, 2024 (CN) 202411466971.5

(51) Int. Cl. B01J 23/745; B01J 37/00

(52) U.S. Cl. CPC B01J 23/745; B01J 37/0045; B01J 37/009

(57) ABSTRACT

Disclosed are a kilogram-scale high-loading iron single-atom catalyst (Fe SAC), and a preparation method and use thereof. Melamine is dissolved in water to obtain a solution A, and cyanuric acid is dissolved in water to obtain a solution B. An organic ligand and a metal salt are dissolved in water to obtain a solution C. The solution B and the solution C are mixed to obtain a solution D. The solution A and the solution D are mixed to obtain a solution E. The solution E is subjected to standing for precipitation for 8-24 hours and a resulting layered solution E is subjected to suction filtration, and a resulting precipitated powder is dried to obtain a precursor. The precursor is heated to a temperature of 500.0-650.0° C. and held at the temperature for 3.0-6.0 hours to obtain the kilogram-scale high-loading Fe SAC.

### CROSS REFERENCE TO RELATED APPLICATION

This patent application claims the benefit and priority of Chinese Patent Application No. 202411466971.5 filed with the China National Intellectual Property Administration on Oct. 21, 2024, and entitled with “KILOGRAM-SCALE HIGH-LOADING IRON SINGLE-ATOM CATALYST, AND PREPARATION METHOD AND USE THEREOF”, the disclosure of which is incorporated by reference herein in its entirety as part of the present application.

### TECHNICAL FIELD

The present disclosure belongs to the field of catalysts, and in particular relates to a kilogram-scale high-loading iron single-atom catalyst, and a preparation method and use thereof.

### BACKGROUND

Single-atom catalyst (SAC) combines the advantages of both homogeneous and heterogeneous catalysts, offering the advantages of high atom utilization, high reaction activity, low material cost, recyclability, and greater stability. Iron is inexpensive and has abundant reserves in nature, and iron-based catalysts tend to have high durability, tunability in acidic and basic media, and high resistance to methanol. The iron single-atom catalyst (Fe SAC) activates peroxymonosulfate (PMS) to generate reactive oxygen species (ROS) in situ, which can effectively remove typical antibiotics and is therefore widely used in advanced oxidation processes (AOPs) in environmental remediation techniques.

Current literature reports that the scale of Fe SACs prepared by various synthetic methods is usually only at the gram or even milligram level, which is far from meeting the requirements of factory production. Conventional preparation methods face technical bottlenecks such as amplification effect, waste liquid pollution, and expensive equipment, making it impossible to produce a single batch at the kilogram-scale. Methods such as immersion, ion exchange, hydrothermal treatment, and coprecipitation lead to the aggregation of metal atoms due to the amplification effect. Selective etching and template loading methods generate large amounts of liquid waste, leading to environmental pollution problems. Mass-separation soft-landing and atomic layer deposition methods are often hampered by the requirements for expensive experimental equipment and low production efficiency. Furthermore, in the existing reports on the macro-scale preparation of Fe SACs, 10.0 grams or more of materials can be synthesized at one time, but their loading amounts are all below 2.0% by mass. Therefore, the industrialization and commercialization of high-loading Fe SACs need to be accelerated.

The breakthrough of the technical bottlenecks of the industrialization and commercialization of high-loading Fe SACs means that, first, the preparation at the kilogram-scale can be achieved, and the large-scale production requires higher requirements for stability of catalysts and agglomeration cannot occur during the preparation process. Secondly, a simple and inexpensive synthesis process is required, while ensuring that the synthesis process is green and environmentally friendly. The present preparation method involves the use of hydrogen bonding to stabilize the self-assembly of an iron-containing precursor and to immobilize the iron atoms to prevent agglomeration during the subsequent pyrolysis process, thus providing the possibility of preparing a kilogram-scale Fe SAC. In addition, during the synthesis process of a single batch of the kilogram-scale high-loading Fe SAC, the solute ratio is reasonably narrowed to reduce the amount of liquids used and the production of waste liquids, and the volume of the precursor is reduced by static settling and suction filtration to facilitate pyrolysis, such that a kilogram-scale high-loading Fe SAC is successfully prepared using such a simple and feasible synthesis process.

### SUMMARY

Given the drawbacks in the prior art, objects of the present disclosure are to provide a kilogram-scale high-loading kilogram-scale high-loading iron single-atom catalyst (Fe SAC), and a preparation method and use thereof.

The objects of the present disclosure have been achieved by the following technical solutions:

In a first aspect, the present disclosure provides a method for preparing a kilogram-scale high-loading iron single-atom catalyst (Fe SAC), including:
(1) dissolving 1.0 g to 1.7 g of melamine in 48.5 mL to 200.0 mL of water to obtain a solution A, and then dissolving 0.5 g to 0.82 g of cyanuric acid in 30.0 mL to 228.0 mL of water to obtain a solution B;
(2) dissolving 0.432 g to 0.452 g of an organic ligand and 0.485 g to 0.50 g of a metal salt in 40.0 mL to 90.0 mL of water to obtain a solution C;
(3) then mixing the solution B and the solution C to obtain a solution D;
(4) then mixing the solution A and the solution D to obtain a solution E;
(5) subjecting the solution E to standing for precipitation for 8.0 h to 24.0 h, subjecting a resulting layered solution E after the standing for precipitation to suction filtration, and drying a resulting precipitated powder to obtain a precursor; and
(6) heating the precursor obtained in step (5) to a temperature of 500.0 degrees Celsius (° C.) to 650.0° C. and holding at the temperature for 3.0 h to 6.0 h to obtain the kilogram-scale high-loading Fe SAC.

In some embodiments, the organic ligand is oxalic acid.

In some embodiments, the metal salt is iron nitrate.

In a second aspect, the present disclosure provides a kilogram-scale high-loading Fe SAC.

In a third aspect, the present disclosure provides use of the kilogram-scale high-loading Fe SAC as mentioned above for degradation of a typical antibiotic.

In some embodiments, the typical antibiotic is one selected from the group consisting of sulfamethoxazole, tetracycline, ciprofloxacin, and levofloxacin.

Some embodiments of the present disclosure have the following beneficial effects:

1) The Fe SAC has excellent stability during the preparation process, which ensures the isolated presence of iron atoms during the pyrolysis process.

2) The synthesis process is simple, reasonable, and suitable for scale-up with low production costs.

3) In the present disclosure, the Fe SAC can be produced at the kilogram-scale, which has similar loading and performance as those of the Fe SACs produced in small batches of gram-scale, ten-gram-scale, and hundred-gram-scale in the laboratory.

### BRIEF DESCRIPTION OF THE DRAWINGS

FIG. 1 shows a synchrotron radiation spectrum of the high-loading Fe SACs of various scales.

FIG. 2 shows a spherical aberration corrected high-angle annular dark-field scanning transmission electron microscope image of the kilogram-scale high-loading Fe SAC according to some embodiments of the present disclosure.

FIG. 3 shows a comparison chart of the Fe loadings in the high-loading Fe SACs of various scales.

FIG. 4 shows a cost analysis diagram of the kilogram-scale high-loading Fe SAC according to some embodiments of the present disclosure.

FIG. 5 is a data comparison graph showing the degradation of a typical antibiotic by PMSs activated using high-loading Fe SACs of various scales.

FIG. 6 shows a comparison chart of the degradation rate of the high-loading Fe SACs of various scales.

### DETAILED DESCRIPTION OF THE EMBODIMENTS

In order to clarify the objective, technical solutions, and advantages of the present disclosure clearer, the present disclosure will be further described in detail with reference to the drawings and examples, and it should be understood that the specific examples described herein are only used to explain the present disclosure and do not encompass all examples. On the basis of the examples of the present disclosure, all other examples that can be obtained by those of ordinary skill in the art without creative efforts shall fall within the scope of the present disclosure.

In the present disclosure, a kilogram-scale high-loading Fe SAC is prepared by using the hydrogen bond self-assembly coupled with high-temperature pyrolysis scheme. In the present disclosure, the high-loading Fe SAC refers to the Fe SAC having an iron loading of over 5.0% by mass. The method includes forming a metal-organic complex by coordination of an organic ligand with metal ions and then dispersing and stabilizing the complex using a precursor formed by self-assembly of hydrogen bonds of melamine with cyanuric acid and complex molecules, wherein hydrogen bonds can play an important role in increasing the melting point of melamine and immobilizing the complexes in the precursor. Therefore, the scheme can address the metal ion migration and atomic agglomeration caused by molten melamine during pyrolysis at a high temperature, thus providing the possibility for preparing a kilogram-scale Fe SAC. In addition, by rationally adjusting the solute ratio of the organic ligand to the metal solution and simplifying the synthetic processes, such as standing and precipitation, and suction filtration of the precursor solution, the production costs can be reduced while achieving the production at the kilogram-scale.

In a first aspect, the present disclosure provides a method for preparing a kilogram-scale high-loading Fe SAC, including the following steps:
(1) dissolving 1.0 g to 1.7 g of melamine in 48.5 mL to 200.0 mL of water to obtain a solution A with a solute ratio of 5.0 g to 35.0 g per liter, and then dissolving 0.50 g to 0.82 g of cyanuric acid in 30.0 mL to 228.0 mL of water to obtain a solution B with a solute ratio of 2.2 g to 27.3 g per liter;
(2) dissolving 0.432 g to 0.452 g of an organic ligand and 0.485 g to 0.50 g of a metal salt in 40.0 mL to 90.0 mL of water to obtain a solution C with a solute ratio of 10.2 g to 23.8 g per liter;
(3) then mixing the solution B and the solution C to obtain a solution D;
(4) then mixing the solution A and the solution D to obtain a solution E;
(5) subjecting the solution E to standing for precipitation for 8.0 h to 24.0 h, subjecting a resulting layered solution E after the standing for precipitation to suction filtration, and drying a resulting precipitated powder to obtain a precursor; and
(6) heating the precursor obtained in step (5) to a temperature of 500.0° C. to 650.0° C. and holding at the temperature for 3.0 h to 6.0 h to obtain the kilogram-scale high-loading Fe SAC.

In some embodiments of the present disclosure, the organic ligand is oxalic acid.

In some embodiments of the present disclosure, the metal salt is iron nitrate.

In a second aspect, the present disclosure provides a kilogram-scale high-loading Fe SAC.

In a third aspect, the present disclosure provides use of the kilogram-scale high-loading Fe SAC as mentioned above for degradation of a typical antibiotic.

In some embodiments, the typical antibiotic is one selected from the group consisting of sulfamethoxazole, tetracycline, ciprofloxacin, and levofloxacin.

### Example 1

(1) 1.5 g of melamine was dissolved in 150.0 mL of water to obtain a solution A with a solute ratio of 10.0 g per liter. Then 0.8 g of cyanuric acid was dissolved in 180.0 mL of water to obtain a solution B with a solute ratio of 4.4 g per liter.
(2) 432.0 mg of oxalic acid and 485.0 mg of ferric nitrate were dissolved in 45.0 mL of water to obtain a solution C with a solute ratio of 20.4 g per liter.
(3) Then the solution B and the solution C were mixed to obtain a solution D.
(4) Then the solution A and the solution D were mixed to obtain a solution E.
(5) The solution E was subjected to standing for precipitation for 12.0 h, after which the solution E was layered significantly. A resulting layered solution E was subjected to suction filtration, and a resulting precipitated powder was dried to obtain a precursor.
(6) The precursor obtained in step (5) was heated to 550.0° C. and then held at the temperature for 4.0 h to obtain 1.0 g of a high-loading Fe SAC, which was denoted as 1-Fe SAC.

### Comparative Example 1

(1) 15.0 g of melamine was dissolved in 1.5 L of water to obtain a solution A with a solute ratio of 10.0 g per liter. Then 8.0 g of cyanuric acid was dissolved in 1.8 L of water to obtain a solution B with a solute ratio of 4.4 g per liter.
(2) 4.32 g of oxalic acid and 4.85 g of ferric nitrate were dissolved in 0.45 L of water to obtain a solution C with a solute ratio of 20.4 g per liter.
(3) Then the solution B and the solution C were mixed to obtain a solution D.
(4) Then the solution A and the solution D were mixed to obtain a solution E.
(5) The solution E was subjected to standing for precipitation for 12.0 h, after which the solution E was layered significantly. A resulting layered solution E was subjected to suction filtration, and a resulting precipitated powder was dried to obtain a precursor.
(6) The precursor obtained in step (5) was heated to 550.0° C. and then held at the temperature for 4.0 h to obtain 10.0 g of a high-loading Fe SAC, which was denoted as 10-Fe SAC.

### Comparative Example 2

(1) 150.0 g of melamine was dissolved in 10.0 L of water to obtain a solution A with a solute ratio of 15.0 g per liter. Then 93.0 g of cyanuric acid was dissolved in 9.3 L of water to obtain a solution B with a solute ratio of 10.0 g per liter.
(2) 43.2 g of oxalic acid and 48.5 g of ferric nitrate were dissolved in 4.5 L of water to obtain a solution C with a solute ratio of 20.4 g per liter.
(3) Then the solution B and the solution C were mixed to obtain a solution D.
(4) Then the solution A and the solution D were mixed to obtain a solution E.
(5) The solution E was subjected to standing for precipitation for 12.0 h, after which the solution E was layered significantly. A resulting layered solution E was subjected to suction filtration, and a resulting precipitated powder was dried to obtain a precursor.
(6) The precursor obtained in step (5) was heated to 550.0° C. and then held at the temperature for 4.0 h to obtain 100.0 g of a high-loading Fe SAC, which was denoted as 100-Fe SAC.

### Comparative Example 3

(1) 1500.0 g of melamine was dissolved in 50.0 L of water to obtain a solution A with a solute ratio of 30.0 g per liter. Then 794.0 g of cyanuric acid was dissolved in 34.0 L of water to obtain a solution B with a solute ratio of 23.4 g per liter.
(2) 432.0 g of oxalic acid and 484.8 g of ferric nitrate were dissolved in 45.0 L of water to obtain a solution C with a solute ratio of 20.4 g per liter.
(3) Then the solution B and the solution C were mixed to obtain a solution D.
(4) Then the solution A and the solution D were mixed to obtain a solution E.
(5) The solution E was subjected to standing for precipitation for 12.0 h, after which the solution E was layered significantly. A resulting layered solution E was subjected to suction filtration, and a resulting precipitated powder was dried to obtain a precursor.
(6) The precursor obtained in step (5) was heated to 550.0° C. and then held at the temperature for 4.0 h to obtain 1000.0 g of a high-loading Fe SAC, which was denoted as 1000-Fe SAC.

### Use Example 1

### Experiment on the Degradation of Sulfamethoxazole Using High-Loading Fe SACs of Different Scales

(1.1) Saturated aqueous solutions of sulfamethoxazole were added to eight 100.0 mL beakers each containing 50.0 mL of deionized water, respectively, resulting in sulfamethoxazole solutions with an initial concentration of 0.05 mL per liter. Every three beakers was a set of parallel experiments, and 1-Fe SAC, 10-Fe SAC, 100-Fe SAC, and 1000-Fe SAC prepared in Example 1 and Comparative Examples 1 to 3 were added thereto, respectively, followed by subjected to sonication-assisted dispersion, and the beakers were then placed on a magnetic stirrer for stirring. Activators PMS with a concentration of 0.5 mL per liter were added to the beakers.

(1.2) After adding the activators, the timing was started, and sampling was conducted at 0.0, 1.0, 2.0, 3.0, 4.0, 5.0, 10.0, and 20.0 minutes using a syringe, respectively. The catalysts in the samples were separated with a 0.22-micron water filter membrane, and resulting samples were added to liquid phase vials.

(1.3) Concentrations of p-chlorophenol in the solutions were determined using a high-performance liquid chromatograph.

### Use Example 2

### Experiment on the Degradation of Tetracycline Using High-Loading Fe SACs of Different Scales

(2.1) Saturated aqueous solutions of tetracycline were added to eight 100 ml beakers each containing 50 mL of deionized water, respectively, resulting in tetracycline solutions with an initial concentration of 0.05 mL per liter. Every three beakers was a set of parallel experiments, and 1-Fe SAC, 10-Fe SAC, 100-Fe SAC, and 1000-Fe SAC prepared in Example 1 and Comparative Example 1 were added thereto, respectively, followed by subjected to sonication-assisted dispersion, and the beakers were then placed on a magnetic stirrer for stirring. Activators PMS with a concentration of 0.5 mL per liter were added to the beakers.

(2.2) After adding the activators, the timing was started, and sampling was conducted at 0.0, 1.0, 2.0, 3.0, 4.0, 5.0, 10.0, 20.0, and 30.0 minutes using a syringe, respectively. The catalysts in the samples were separated with a 0.22-micron water filter membrane, and resulting samples were added to liquid phase vials.

(2.3) Concentrations of tetracycline in the solutions were determined using a high-performance liquid chromatograph.

### Use Example 3

### Experiment on the Degradation of Ciprofloxacin Using High-Loading Fe SACs of Different Scales

(3.1) Saturated aqueous solutions of ciprofloxacin were added to eight 100.0 mL beakers each containing 50.0 mL of deionized water, respectively, resulting in ciprofloxacin solutions with an initial concentration of 0.05 mL per liter. Every three beakers was a set of parallel experiments, and 1-Fe SAC, 10-Fe SAC, 100-Fe SAC, and 1000-Fe SAC prepared in Example 1 and Comparative Examples 1 to 3 were added thereto, respectively, followed by subjected to sonication-assisted dispersion, and the beakers were then placed on a magnetic stirrer for stirring. Activators PMS were added with a concentration of 0.5 mL per liter to the beakers.

(3.2) After adding the activators, the timing was started, and sampling was conducted at 0.0, 1.0, 2.0, 3.0, 4.0, 5.0, 10.0, 20.0, and 30.0 minutes using a syringe, respectively. The catalysts in the samples were separated with a 0.22-micron water filter membrane, and resulting samples were added to liquid phase vials.

(3.3) Concentrations of ciprofloxacin in the solutions were determined using a high-performance liquid chromatograph.

### Use Example 4

### Experiment on the Degradation of Levofloxacin Using High-Loading Fe SACs of Different Scales

(4.1) Saturated aqueous solutions of levofloxacin were added to eight 100.0 mL beakers each containing 50.0 mL of deionized water, respectively, resulting in levofloxacin solutions with an initial concentration of 0.05 mL per liter. Every three beakers was a set of parallel experiments, and 1-Fe SAC, 10-Fe SAC, 100-Fe SAC, and 1000-Fe SAC prepared in Example 1 and Comparative Examples 1 to 3 were added thereto, respectively, followed by subjected to sonication-assisted dispersion, and the beakers were then placed on a magnetic stirrer for stirring. Activators PMS with a concentration of 0.5 mL per liter were added to the beakers.

(4.2) After adding the activators, the timing was started, and sampling was conducted at 0.0, 1.0, 2.0, 3.0, 4.0, 5.0, 10.0, 20.0, and 30.0 minutes using a syringe, respectively. The catalysts in the samples were separated with a 0.22-micron water filter membrane, and resulting samples were added to liquid phase vials.

(4.3) Concentrations of levofloxacin in the solutions were determined using a high-performance liquid chromatograph.

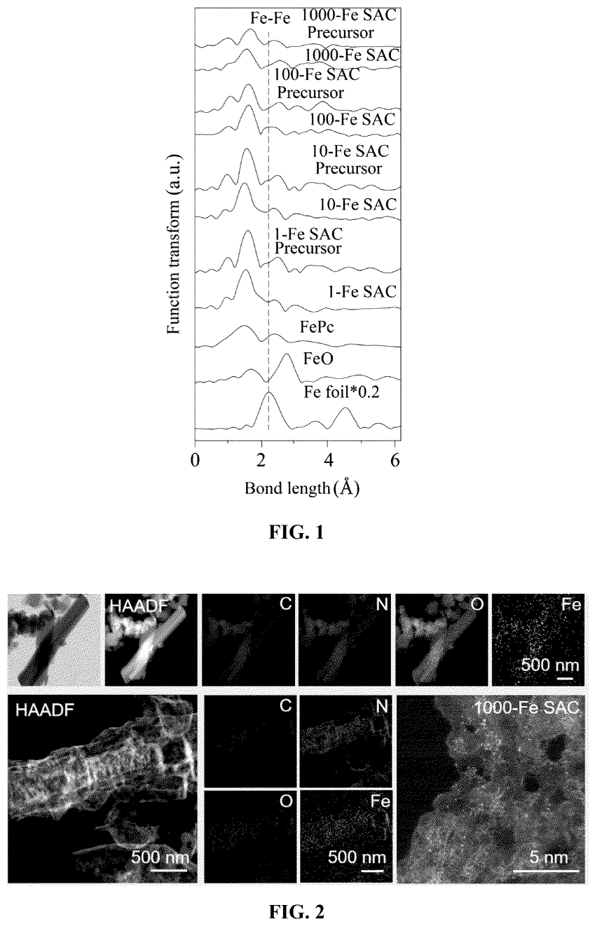

As shown in the synchrotron radiation spectrum of FIG. 1, compared to an iron (Fe) foil standard product, no iron-iron bond is observed before (a precursor) and after (a finished catalyst) the calcination of 1-Fe SAC, 10-Fe SAC, 100-Fe SAC, and 1000-Fe SAC, indicating that monometallic iron does not agglomerate and is coordinated with nitrogen in a similar state to iron phthalocyanine (FePc). As shown in FIG. 2, bright spots of metal atoms can be clearly seen in the spherical aberration corrected high-angle annular dark-field scanning transmission electron microscope image of the preparation of 1000-Fe SAC. This indicates that the iron atoms are in the form of single-atoms, confirming the successful preparation of a large-scale Fe SAC.

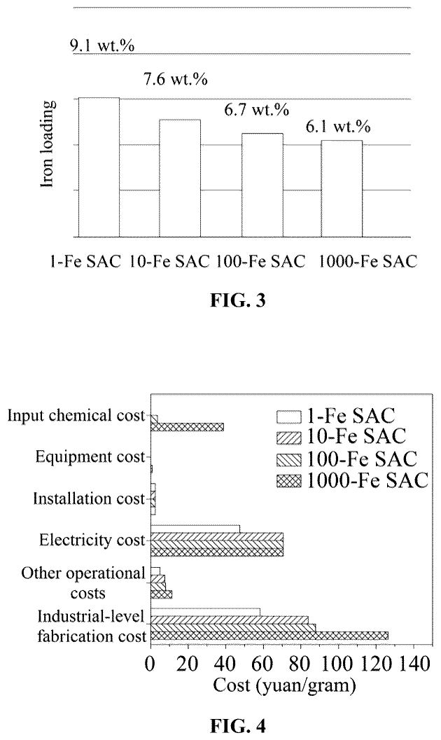

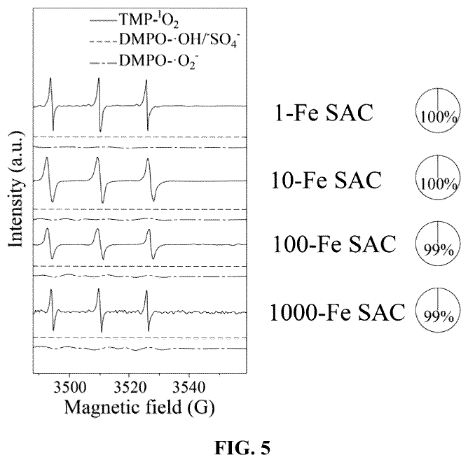

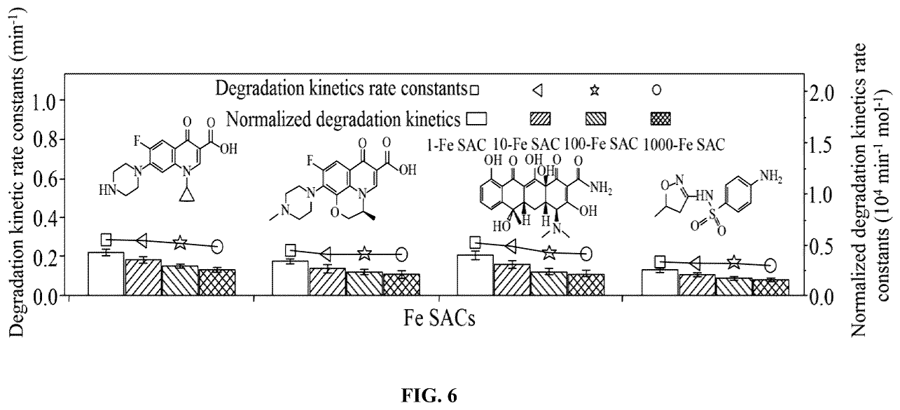

FIG. 3 shows that the kilogram-scale high-loading Fe SAC prepared in the present disclosure has an extremely high metal loading, with the iron content in the 1000-gram Fe SAC being as high as 6.1% by mass. FIG. 4 shows pictures of the real high-loading Fe SACs produced in both small batches and large-scale production, along with a cost analysis. It can be seen that the production cost is 128.0 yuan per kilogram at the kilogram-scale, with the primary expenses attributed to raw materials and electricity bills, and the cost increase from the gram to the kilogram-scale is minimal. As shown in FIG. 5, 102 active species are generated when all the Fe SACs from gram to kilogram-scale are used to activate PMSs. As shown in FIG. 6, taking four typical antibiotics as an example, the kilogram-scale high-loading Fe SAC prepared in the present disclosure has better catalytic properties, the rates of the degradation system in which PMS is activated by the high-loading Fe SACs prepared at different scales are substantially the same, and the rate constants at a single iron atom site are similar, indicating that the production process has been successfully scaled up to achieve the goal of scale-up preparation of Fe SACs.

In the present disclosure, a kilogram-scale high-loading Fe SAC is prepared by using the hydrogen bond self-assembly coupled with high-temperature pyrolysis scheme at a large scale. The method provided by the present disclosure includes forming a metal-organic complex by coordination of an organic ligand with metal ions and then dispersing and stabilizing the complex using a precursor formed by self-assembly of hydrogen bonds of melamine with cyanuric acid and complex molecules, wherein hydrogen bonds can play an important role in increasing the melting point of melamine and immobilizing the complexes in the precursor. Therefore, the scheme can address the metal ion migration and atomic agglomeration caused by molten melamine during pyrolysis at a high temperature, thus providing the possibility of scale-up preparation. In addition, by rationally adjusting the solute ratio of the organic ligand to the iron ion solution and simplifying the synthetic processes, such as standing and precipitation, and suction filtration of the precursor solution, the production costs can be reduced while achieving production at the kilogram-scale. The kilogram-scale high-loading Fe SAC prepared in the present disclosure has the following advantages: 1. The single-atom has excellent stability during the preparation process, which ensures the isolated presence of the iron atoms during the pyrolysis process. 2. The synthesis process is simple, reasonable, and suitable for scale-up with low production costs. 3. The Fe SAC can be produced by this method at a kilogram-scale, which has similar loading and performance as those of the Fe SACs produced at the gram-scale. This provides a new solution to the scale-up preparation of the kilogram-scale high-loading Fe SACs and offers new ideas for the industrialization and commercialization of SACs.

The foregoing descriptions are merely preferred embodiments of the present disclosure and are not intended to limit the present disclosure. Any modification, equivalent replacement, or improvement made without departing from the spirit and principle of the present disclosure shall fall within the scope of the present disclosure.

What is claimed is:

1. A method for preparing a kilogram-scale high-loading iron single-atom catalyst (Fe SAC), comprising:
(1) dissolving 1.0 gram (g) to 1.7 g of melamine in 48.5 milliliters (mL) to 200.0 mL of water to obtain a solution A, and then dissolving 0.5 g to 0.82 g of cyanuric acid in 30.0 mL to 228.0 mL of water to obtain a solution B;
(2) dissolving 0.432 g to 0.452 g of an organic ligand and 0.485 g to 0.5 g of a metal salt in 40.0 mL to 90.0 mL of water to obtain a solution C;
(3) mixing the solution B and the solution C to obtain a solution D;
(4) mixing the solution A and the solution D to obtain a solution E;
(5) subjecting the solution E to standing for precipitation for 8.0 hours to 24.0 hours, subjecting a resulting layered solution E after the standing for precipitation to suction filtration, and drying a resulting precipitated powder to obtain a precursor; and
(6) heating the precursor obtained in step (5) to a temperature of 500.0 degrees Celsius (° C.) to 650.0° C. and holding at the temperature for 3.0 hours to 6.0 hours to obtain the kilogram-scale high-loading Fe SAC.

2. The method of claim 1, wherein the organic ligand is oxalic acid.

3. The method of claim 1, wherein the metal salt is iron nitrate.

4. A kilogram-scale high-loading Fe SAC prepared by the method of claim 1.

5. The kilogram-scale high-loading Fe SAC of claim 4, wherein the organic ligand is oxalic acid.

6. The kilogram-scale high-loading Fe SAC of claim 4, wherein the metal salt is iron nitrate.
